(19) United States
(12) Patent Application Publication
(10) Pub. No.: US 2026/0251238 A1
(43) Pub. Date: Aug. 27, 2026

(54) RING FOR SUPPORTING ONE OR MORE PIPES A SUPPORTING HANGER FOR CONNECTING WITH SAID RING, AND A COMBINATION THEREOF

(71) Applicant: Centrotherm Eco Systems, LLC, Waterford, NY (US)

(72) Inventors: Kiernan ANDERSON, Waterford, NY (US); Kevin SHAW, Waterford, NY (US)

(21) Appl. No.: 19/059,518

(22) Filed: Feb. 21, 2025

(51) Int. Cl. F16L 3/11; F16L 3/10

(52) U.S. Cl. CPC F16L 3/11; F16L 3/1075

(57) ABSTRACT

Disclosed is a combination of a ring for connecting two pipes and a supporting hanger for connecting with said ring, wherein said hanger can be installed to a supporting structure such as a wall. Also disclosed is the ring per se, and the supporting hanger per se.

The present invention relates to a combination of a ring for supporting one or more pipes and preferably also for connecting two pipes, and a supporting hanger for connecting with said ring, wherein said hanger can be installed to a supporting structure such as a wall. The invention also relates to said ring as such. The invention also relates to the supporting hanger as such.

INTRODUCTION

Piping works, such as piping works for flue gas, often require interconnection of consecutive pipes and supporting the piping works to supporting structures such as walls, ceilings, floors, or any other supporting structures. This is often associated with challenges in the sense of installation.

The present invention aims at the provision of a versatile means for connecting and preferably also supporting pipes which allows quick and easy installation in various directions, including horizontal and vertical installation of the pipes.

### SUMMARY OF THE INVENTION

These objectives are achieved by the present invention.

In a first aspect the invention relates to a combination of a ring with a supporting hanger, comprising a ring for supporting one or more pipes and preferably also connecting two pipes, wherein said ring comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto; and a supporting hanger with an elongated shape, comprising two parallel first slots extending in a direction perpendicular with respect to the longitudinal direction of the hanger and which first slots are positioned opposite to each other in a plane perpendicular with respect to the longitudinal direction of the hanger and adapted to accommodate opposite laterally outwardly projecting elements extending from the top part of the elevation of the hanger connection platform of the ring and a tab between and in a staggered position with respect to the plane of said first slots, wherein said tab comprises a hook extending downward and configured to engage behind the top of said elevation and on the opposite side of said hook a restraining means so as to lock said top part of the hanger connection platform between said hook and said restraining means; and comprising two parallel second slots extending in a direction perpendicular with respect to the longitudinal direction of the hanger and which second slots are positioned opposite to each other in a plane in longitudinal direction of the hanger and adapted to accommodate opposite laterally projecting elements extending from the top part of the elevation of the hanger connection platform of the ring and a tab between and in a staggered position with respect to the plane of said second slots, wherein said tab comprises a hook extending downward and configured to lock behind the top of said elevation and on the opposite side of said hook a restraining means so as to lock said top part of the hanger connection platform between said hook and said restraining means.

In a second aspect, the invention relates to the ring as such. In this respect, the invention also relates to a ring for supporting one or more pipes and preferably also connecting two pipes, wherein said ring comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto.

In a third aspect, the invention relates to the supporting hanger as such. In this respect, the invention also relates to as supporting hanger with an elongated shape for connecting with the ring according to the second aspect, comprising two first slots opposite to each other in a plane perpendicular with respect to the longitudinal direction of the hanger and adapted to accommodate opposite projections extending from the top part of the elevation of the hanger connection platform of the ring and a tab between and in a staggered position with respect to the plane of said first slots, wherein said tab comprises a hook extending downward and configured to lock behind the top of said elevation and on the opposite side of said hook a restraining means so as to lock said top part of the hanger connection platform between said hook and said restraining means; and comprising two second slots opposite to each other in a plane in longitudinal direction of the hanger and adapted to accommodate opposite projections extending from the top part of the elevation of the hanger connection platform of the ring and a tab between and in a staggered position with respect to the plane of said second slots, wherein said tab comprises a hook extending downward and configured to lock behind the top of said elevation and on the opposite side of said hook a restraining means so as to lock said top part of the hanger connection platform between said hook and said restraining means.

In a fourth aspect the invention relates to a computer-readable medium having computer-executable instructions adapted to cause a 3D printer to print the ring of the second aspect of the invention and/or the supporting hanger of the third aspect of the invention.

The connection between the above defined ring and supporting hanger and therefore the above defined combination allows for versatile connecting and supporting pipes and pipeworks of interconnected pipes by allowing quick and easy installation of the hanger with respect to the ring in various directions at 90 degree intervals, and allows also horizontal and vertical installation of the pipes supported and optionally interconnected by the ring.

### BRIEF DESCRIPTION OF THE DRAWINGS

FIG. 1 shows a ring for connecting two pipes and supporting the assembly of pipes in accordance with an exemplary embodiment of the invention in a closed position.

FIG. 2 shows the ring of FIG. 1 in an opened position with a view in the inside of the ring. FIG. 2 does not show the teeth 110 that are shown in FIG. 1.

FIG. 3 shows the ring of FIGS. 1 and 2 in an opened position with a view in the outside of the ring. FIG. 3 does not show the teeth 110 that are shown in FIG. 1.

FIG. 4A shows how the ring of FIG. 1 is installed to connect two pipes in a first step.

FIG. 4B shows how the ring of FIG. 1 is installed to connect two pipes in a second step.

FIG. 4C shows how the ring of FIG. 1 is installed to connect two pipes in a third step.

FIG. 5 shows an installed ring of FIG. 1 with a support rod screwed therein.

FIG. 6 shows a supporting hanger in accordance with an exemplary embodiment of the invention.

FIG. 7A shows how the supporting hanger of FIG. 6 can be attached to the ring of FIG. 1 in a first step of a first mode.

FIG. 7B shows how the supporting hanger of FIG. 6 can be attached to the ring of FIG. 1 in a second step of a first mode.

FIG. 8A shows how the supporting hanger of FIG. 6 can be attached to the ring of FIG. 1 in a first step of a second mode.

FIG. 8B shows how the supporting hanger of FIG. 6 can be attached to the ring of FIG. 1 in a second step of a second mode.

FIG. 9A shows how the supporting hanger of FIG. 6 functions as hanger attached to the ring of FIG. 1 in one embodiment and how the hanger can be mounted to a wall.

FIG. 9B shows how the supporting hanger of FIG. 6 functions as hanger attached to the ring of FIG. 1 in another embodiment and how the hanger can be mounted to a wall.

FIG. 10A shows how the supporting hanger of FIG. 6 functions as hanger attached to the ring of FIG. 1 in another embodiment and how the hanger can be mounted to a wall.

FIG. 10B shows how the supporting hanger of FIG. 6 functions as hanger attached to the ring of FIG. 1 in another embodiment and how the hanger can be mounted to a wall.

FIG. 10C shows how the supporting hanger of FIG. 6 functions as hanger attached to the ring of FIG. 1 in another embodiment and how the hanger can be mounted to a wall.

FIG. 11 shows a pipe work of multiple pieces of pipe interconnected with the ring of FIG. 1 with a hanger according to FIG. 6 attached thereto.

### DETAILED DESCRIPTION OF THE INVENTION

The present invention is based on one hand on the provision of a hanger connection platform as defined above on a ring for supporting one or more pipes and optionally, and preferably, also for connecting two pipes that allows connection in various directions with 90 degrees intervals, and on the other hand, on the provision of engaging connection parts of the hanger that allow connection with the hanger with the hanger parallel to the direction of the pipe or transverse to the pipe.

Because the connection hanger platform comprises elements projecting outward of the top of elevation on both sides in longitudinal direction of the ring and on both sides in the direction perpendicular thereto, the slots of the hanger can be slid over the elements in four different orientations, namely in two opposite directions in circumferential direction of the ring and in two opposite directions in the longitudinal direction of the connector, allowing to adapt the orientation of the hanger in 90 degrees intervals, demonstrating the versatility of the combination of ring and hanger.

The provision of the two first slots opposite to each other in a plane perpendicular with respect to the longitudinal direction of the hanger and the two second slots opposite to each other in a plane in longitudinal direction of the hanger allows connection with the hanger with the hanger extending parallel to the direction of the pipe or transverse to the pipe.

In the present specification any explanation with regard to the ring may also apply to the combination of the ring with the supporting hanger and vice versa.

Likewise, any explanation with regard to the supporting hanger may also apply to the combination of the ring with the supporting hanger and vice versa.

For purposes of the present invention any ring suitable for supporting one or more pipes may be envisaged.

It is preferred that apart from its supporting function the ring also functions as a connection ring for interconnecting two pipes. Any kind of pipe accommodating to these purposes may be envisaged as long as the abovementioned connection hanger platform is present on its outer side. Such a ring may, apart from this connection hanger platform, in principle comprise features and dimensions that are known in the art.

The materials of both the ring and the supporting hanger may suitably be chosen among the standard materials and depending on the specific purposes, including but not limited to plastics, for instance selected from polypropylene, polyethylene and polyvinyl chloride. The ring and/or supporting hanger as disclosed in the context of the present invention may be produced by any suitable molding technique, but may also be made by 3D printing. In this respect, the invention also relates to a computer-readable medium having computer-executable instructions adapted to cause a 3D printer to print the ring and/or the supporting hanger. It is well known in the art how to compose such instructions on the basis of 3D design drawing.

In a particular suitable embodiment, the ring is configured such that it can be reversibly opened and closed.

For this purpose the ring may be provided with a hinge. In this case the ring has a cleft extending in longitudinal direction of the ring, i.e. in the direction of insertion of the pipes to be connected, and opposite to the hinge, so that upon opening of the ring the hinge separates two hinged halves of the ring. Such a ring thus functions both as a locking clamp as well as a support clamp for pipes.

Clicking arms with hooks may be provided and positioned on the outer side of the ring opposite to the hinge. These clicking arms are preferably provided on each side of the cleft with the ends of the arms with said hooks extending in opposite direction allow to allow locking the ring firmly in a closed position. These hooks are preferably provided at these ends and can engage with protrusions provided on the outer side of the ring. To open the ring, the ends of these clicking arms can be pulled in a direction away from the outer side of the ring to unlock hooks of the clicking arms.

In an embodiment, cavities are provided on either side of the cleft with a thread and designed so that after closing the ring a connection point is created into which a screw rod, for instance a ⅜″ threaded rod, can be screwed. This allows the provision of further support or the connection to other components or equipment. In a preferred embodiment therefore, the ring comprises a hinge extending in longitudinal direction of the ring and a cleft opposite to the hinge, so that in an opened position of the ring the hinge separates two hinged halves of the ring; wherein cavities are provided opposite to each other and aligned with each other on either side of the cleft, which cavities are provided with a thread such that upon closing the ring a threaded hole is provided.

This opens the possibility to close the ring around a threaded rod when clamping the ring together, and thus clamping the rod between two opposite cavities, and also screw a threaded rod into the threaded hole of the ring when it is already in closed condition.

In another preferred embodiment, the ring is provided with one or more adjustable means for providing a tight grip on various diameters of pipes.

The ring may be provided with locking teeth, for instance metal locking teeth, on its inner side to allow for extra grip on the pipe.

Alternatively, or in addition, other adjustable means for providing a tight grip on various diameters of pipes may be provided at an end of the ring. This is preferably the opposite end in relation to the metal locking teeth (if present) as seen in its insertion direction. In a preferred embodiment the adjustable means are springs. These may for instance be in the form of leaf springs provided in the circumference of the ring at the opposite end in relation to the metal locking teeth as seen in its insertion direction. Such leaf springs allow for a tight grip on various diameters of pipes.

As mentioned above, the ring comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto.

In a preferred embodiment at least the top part of the elevation has a substantially square circumference. This allows easy design and facilitates considerations with regard to the engaging supporting hanger elements. It also contributes to uniform distribution of forces.

For the same reason it is preferred that said elevation is a hollow, walled elevation having a substantially rectangular, preferably substantially square circumference.

In a preferred embodiment said laterally and outwardly projecting elements are positioned on each corner on top of the elevation, and wherein each element positioned on one of the corners projects in longitudinal direction of the ring and in the direction perpendicular thereto. In other words, four of these elements are provided and distributed at positions on each corner on top of the elevation. In this embodiment the ring thus preferably comprises a hanger connection platform comprising an elevation extending from the outer side of the ring, wherein at least the top part of the elevation has a substantially square circumference and four elements, each laterally projecting from the top of the elevation in longitudinal direction of the ring and in the direction perpendicular thereto.

In a preferred, compact and robust design said laterally and outwardly projecting elements are positioned on each corner on top of the elevation with a recess between each neighboring element, which recess is configured to engage with a hook of a said tab of said supporting hanger.

For further robustness of the connection between ring and supporting hanger the ring comprises support fins on its outer side and positioned laterally adjacent from the hanger connection platform and dimensioned to abut the hanger when connected. These support fins provide the side or bottom of the hanger with a firm basis which prevent wobbling movements at the connection between hanger and ring.

The hanger that can be connected to this hanger connection platform is a supporting hanger with an elongated shape for supporting the ring in a connection of with a support structure, such as a wall.

In a preferred and practical embodiment said hanger is in the shape of an elongated slat. Such a slat can be easily cut to any suitable size if desired.

The hanger comprises two first slots extending in a direction perpendicular of the longitudinal direction of hanger and positioned opposite to each other in a plane perpendicular of longitudinal direction of the hanger. They are adapted to accommodate opposite projections extending from the top part of the elevation of the hanger connection platform of the ring.

A tab is provided between and in a staggered position with respect to the plane of said first slots, wherein said tab suitably comprises a hook configured to lock behind the top of said elevation and on the opposite side of said hook a restraining means so as to lock the top part of the hanger connection platform between said hook and said restraining means. Said restraining means may in a practical embodiment correspond to a backing wall of the hanger.

The hanger also comprises two parallel second slots extending in a direction perpendicular of the longitudinal direction of hanger and positioned opposite to each other in a plane in longitudinal direction of the hanger and also adapted to accommodate opposite projections extending from the top part of the elevation of the hanger connection platform of the ring. Also here the hanger suitably comprises a tab between and in a staggered position with respect to the plane of said second slots, wherein said tab comprises a hook configured to lock behind the top of said elevation and on the opposite side of said hook a restraining means so as to lock said top part of the hanger connection platform between said hook and said restraining means. Also here, the restraining means in a practical embodiment may correspond to a backing wall of the hanger.

In a practical design, the supporting hanger comprises at a first end a connector connection part configured for connection with said hanger connection platform of the ring, and wherein said connector connection part comprises said first and second slots and corresponding tabs, hooks and restraining means. The hanger in this embodiment preferably comprises at a second end opposite to said first end a hanger elongation element, configured to connect a second hanger thereto. This may a hanger having the same design. For this purpose, the hanger elongation element preferably has the same configuration as the hanger connection platform in order to connect a second hanger in the same way as the connection with the ring connector takes place.

The supporting hanger may suitably be provided with holes for installation to a supporting structure such as a wall. It is preferred that the hanger is provided on two right angled sides with holes for installation of the hanger to a supporting structure. This allows easy installation of the hanger from four sides thereof to a support structure such as wall by means of suitable means such as screws or nails.

The ring and the combination of ring and connecting hanger may be used for any piping system, for instance but not limited to flue gas pipe systems.

### DETAILED DESCRIPTION OF THE DRAWINGS

The following drawings are meant to explain the invention and not to limit the scope of the claims. Although the presentation of the ring and hanger may not be the same for each figure, corresponding elements are indicated with the same reference numbers for the sake of legibility.

The ring 1 as shown in the present drawings has an inner side 11 and an outer side 12.

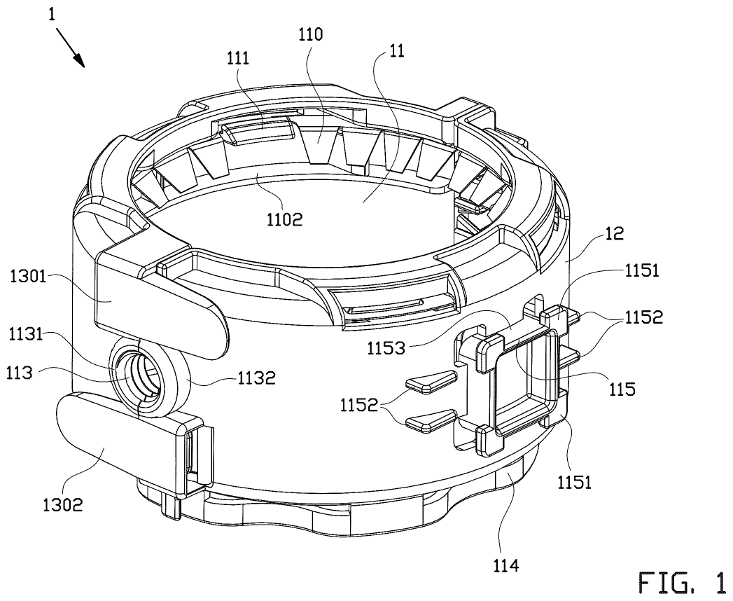

As can be seen best in FIGS. 1, 2 and 3 the ring can be opened and closed by the provision of hinge 18 and clicking arms 1301 and 1302 positioned opposite to the hinge 18. For this purpose, the ring 1 is provided with a cleft extending in longitudinal direction of the ring, i.e. in the direction of insertion of the pipes to be connected, and opposite to the hinge, so that upon opening of the ring 1 the hinge 18 separates two halves of the ring. To open the ring the ends of these arms 1301 and 1302 are pulled in a direction away from the outer side 12 to unlock hooks 1303 provided at these ends and engaging with protrusions 1304, 1305 provided on the outer side of the ring. Clicking arms 1301 and 1302 are provided on each side of the cleft with the ends of the arms with said hooks 1303 extending in opposite direction allow to lock the ring firmly in its closed position. Further provisions to strengthen the integrity of the ring when closed are provided by means of tab 19 on the side of the cleft, configured to engage with a recess behind arm 1302; and on the side of the hinge by means of engaging elements 1401 and 1402, 1501 and 1502, 1601 and 1602 and 1701 and 1702, which combination fit into each other when the ring is closed.

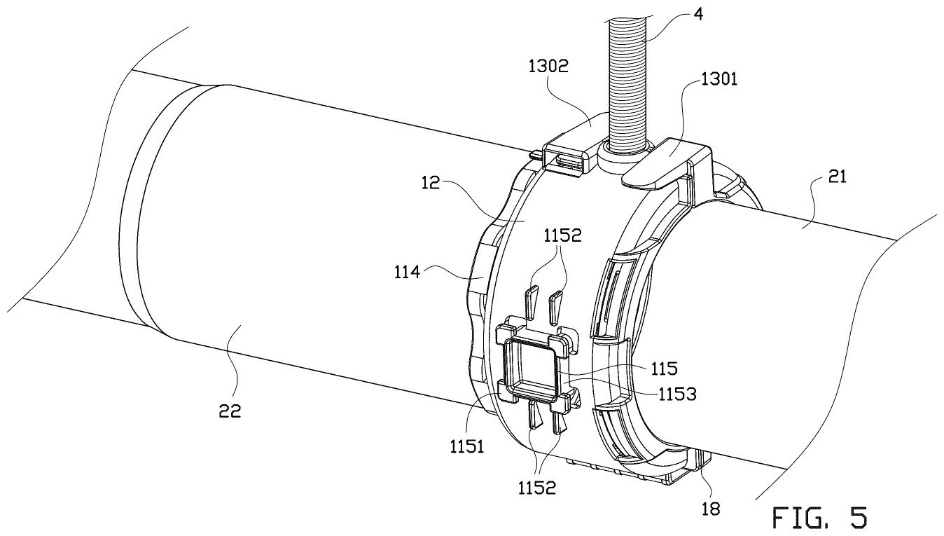

The two cavities 1131 and 1132 provided on either side of the gap are provided with a thread so that after closing the ring 1 a connection point 113 is created into which a screw rod 4 can be screwed (this can be seen best in FIG. 5).

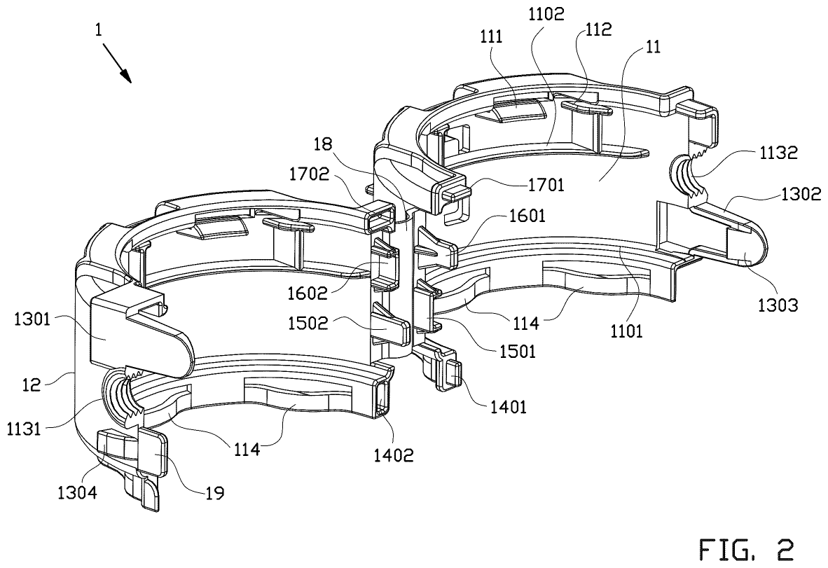

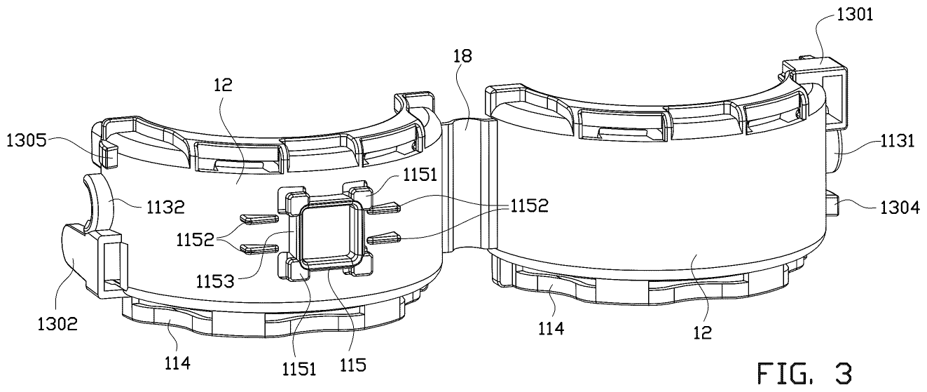

Metal locking teeth 110 (not shown in FIGS. 2 and 3) are provided between multiple tabs 111 and 112. These teeth 110 allow for extra grip on the pipe 21. Likewise leaf springs 114 that allow flexibility in and outward of pipe 22 are provided on the other side of the connector 1 as seen in its insertion direction. These leaf springs 114 allow a tight grip on various diameters of pipes.

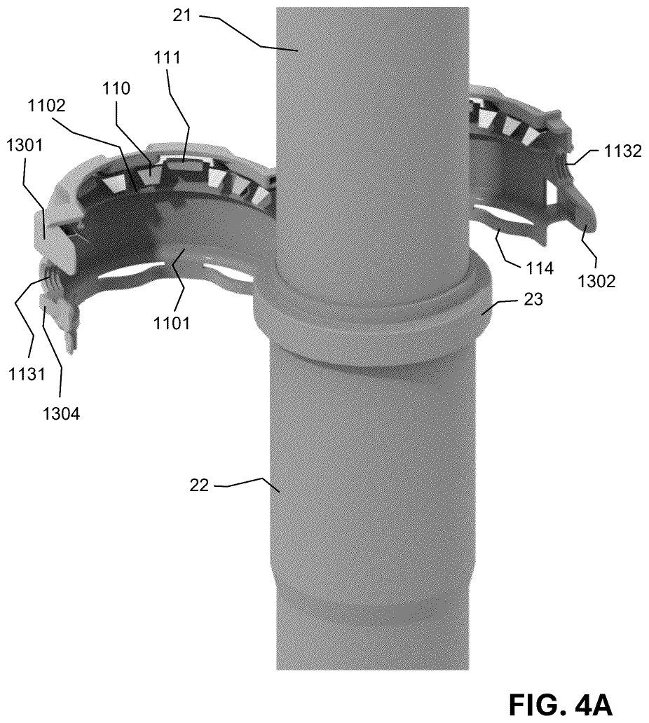

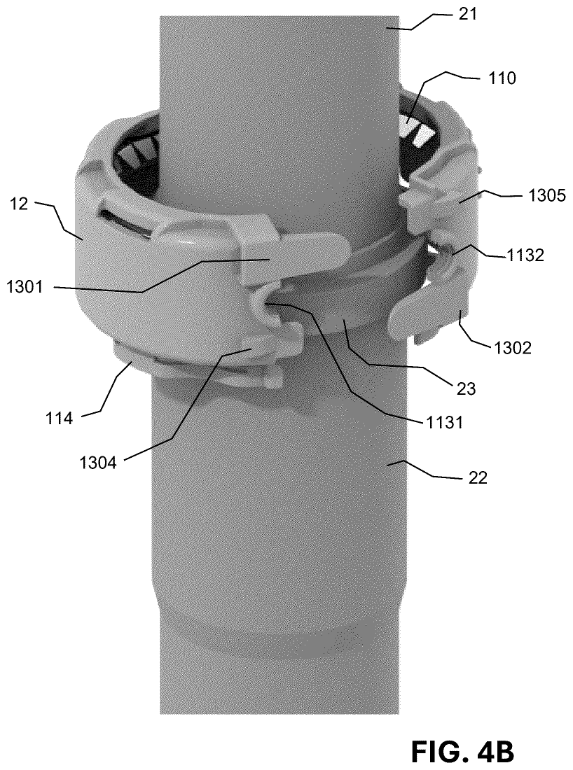

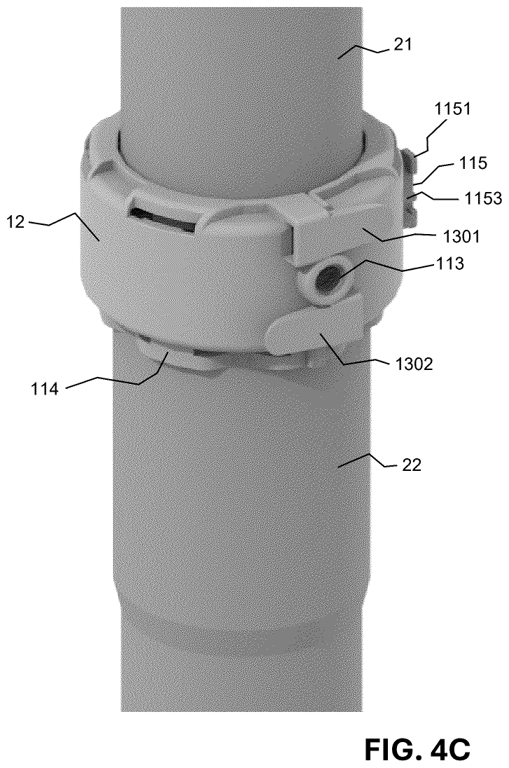

FIG. 4A shows how ring 1 can be installed to connect two pipes in three consecutive steps (FIG. 4A, FIG. 4B and FIG. 4C). As shown in FIG. 4A the ring 1 can be folded around a connection point of two pipes 21, 22. The connection in the present drawings relates to a connection of the male/female type. In many cases of connections of this type the female end of a pipe is configured as a socket in which a male end of a second pipe can be inserted. In the present case the socket of pipe 22 forms an outwardly protruding edge 23, wherein the male end of pipe 21 can be inserted in the female socket of pipe 22. In the present embodiment the inner side 11 of the ring comprises seatings 1101 and 1102 between which outwardly protruding edge 23 can be accommodated. As shown in FIG. 4B the opened ring can be closed by means of hinge 18 and its closed position can be secured (FIG. 4C) with clicking arms 1301 and 1302 by engaging the hooks 1303 of the respective clicking arms behind the respective protrusions 1304, 1305 provided on the outer side of the ring 1.

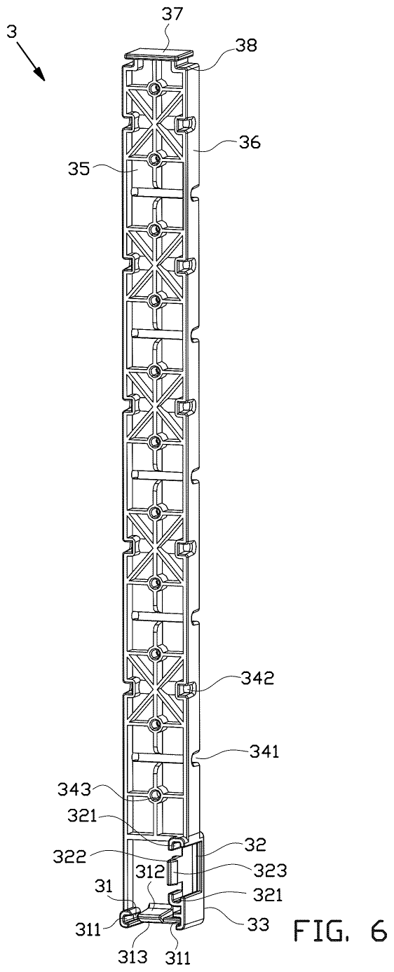

Ring 1 is provided with a hanger connection platform 115 configured for connection with hanger 3 (which is shown in detail in FIG. 6.). The ring 1 comprises a hanger connection platform 115 comprising an elevation 1153 extending from the outer side 12 of the ring 1, wherein at least the top part of the elevation 1153 has a substantially square circumference and four elements 1151 laterally projecting from the top of the elevation 1153. Said four elements 1151 are positioned on each corner on top of the elevation 1153.

As shown in FIG. 6 the hanger that can be connected to this hanger connection platform is a supporting hanger 3 with an elongated shape for supporting the ring in a connection of with a support structure, such as a wall, comprising two first slots 311 extending in a direction perpendicular of the longitudinal direction of hanger 3 and positioned opposite to each other in a plane perpendicular of longitudinal direction of the hanger 3 and adapted to accommodate opposite projections 1151 extending from the top part of the elevation 1153 of the hanger connection platform 115 of the ring 1 and a tab 312 between and in a staggered position with respect to the plane of said first slots 311, wherein said tab 312 comprises a hook 313 extending downward and configured to lock behind the top of said elevation 1153 and on the opposite side of said hook a restraining means 31 so as to lock the top part of the hanger connection platform 115 between said hook 313 and said restraining means 31. Restraining means 31 in FIG. 6 basically corresponds to a backing wall of the hanger.

The hanger 3 also comprises two parallel second slots 321 extending in a direction perpendicular of the longitudinal direction of hanger 3 and positioned opposite to each other in a plane in longitudinal direction of the hanger 3 and adapted to accommodate opposite projections 1151 extending from the top part of the elevation 1153 of the hanger connection platform 115 of the ring 1 and a tab 322 between and in a staggered position with respect to the plane of said second slots 321, wherein said tab 322 comprises a hook 323 extending downward and configured to lock behind the top of said elevation 1153 and on the opposite side of said hook 323 a restraining means 32 so as to lock said top part of the hanger connection platform 115 between said hook 323 and said restraining means 32. Restraining means 32 in FIG. 6 also basically corresponds to a backing wall of the hanger.

The first slots 311 and second slots 321 form two parallel rails for sliding in the opposite projections 1151 extending from the top part of the elevation 1153 of the hanger connection platform 115 of the ring 1. Because these rails are positioned perpendicular with respect to each other the hanger can be used to support the ring and thus the piping system held by it in various orientations. This effect is even more increased by the fact that the hanger connection platform 115 may be inserted into said rails from four sides of the top of the platform. This makes the combination of said ring and said hanger a powerful tool to support and connect pipes in one action and in various orientations with regard to a structure to which the pipes are to be fixed, such as a wall 6.

The hanger 3 is preferably in the shape of a slat as shown in the present figures and in detail in FIG. 6. Both assemblies of first and second slots 311, 321 and corresponding tabs, hooks and restraining means are preferably concentrated in a dedicated part of the hanger 3, for instance a connector connection part 33 housing both assemblies in a dedicated part of the hanger 3.

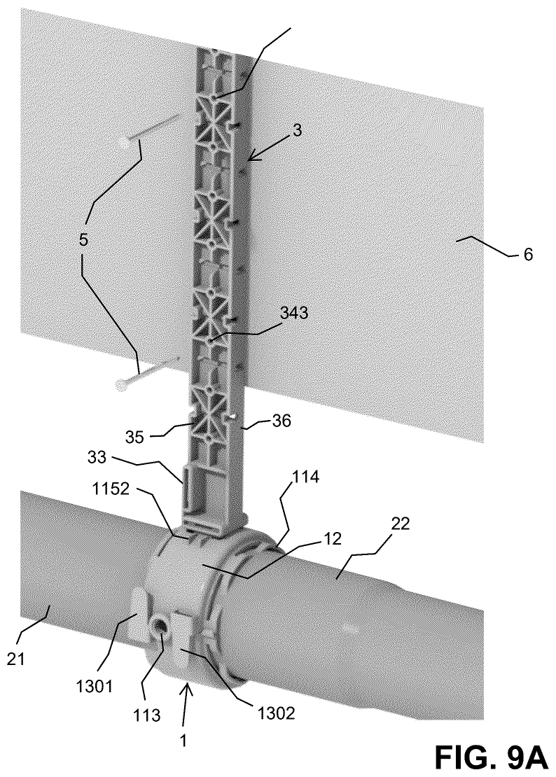

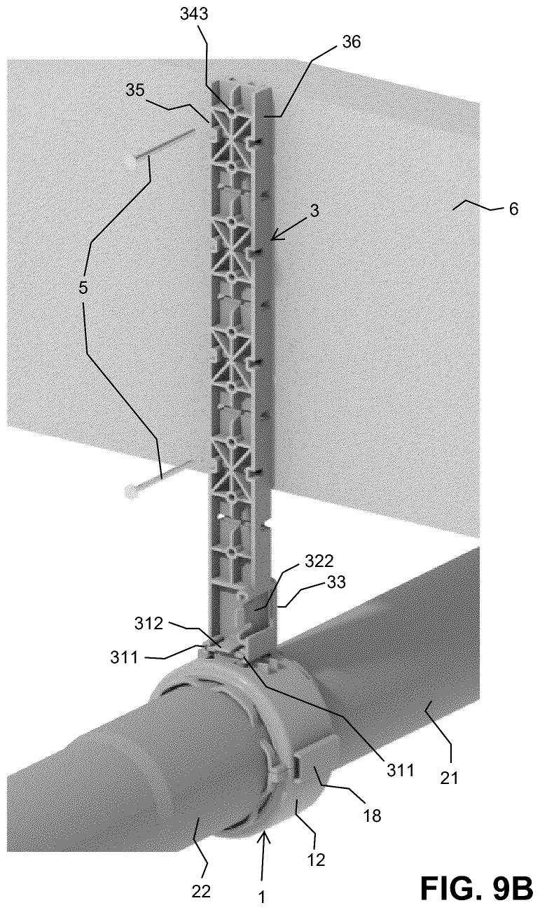

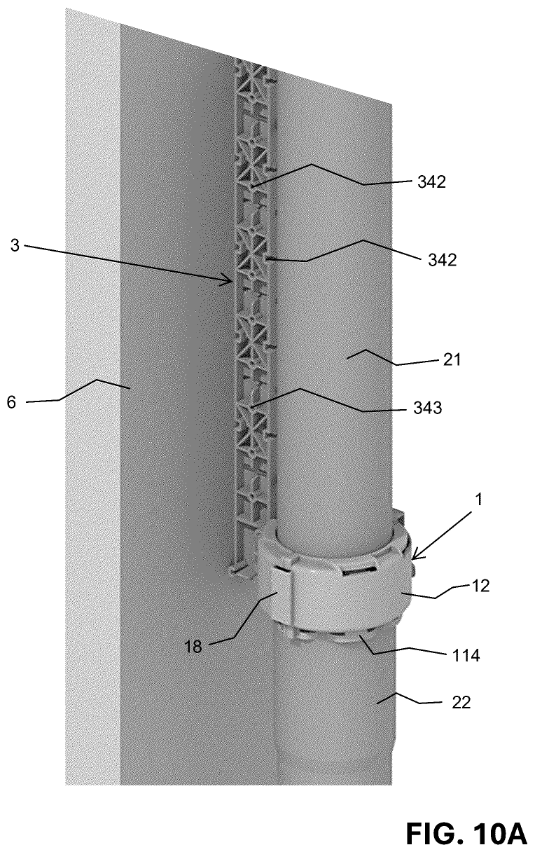

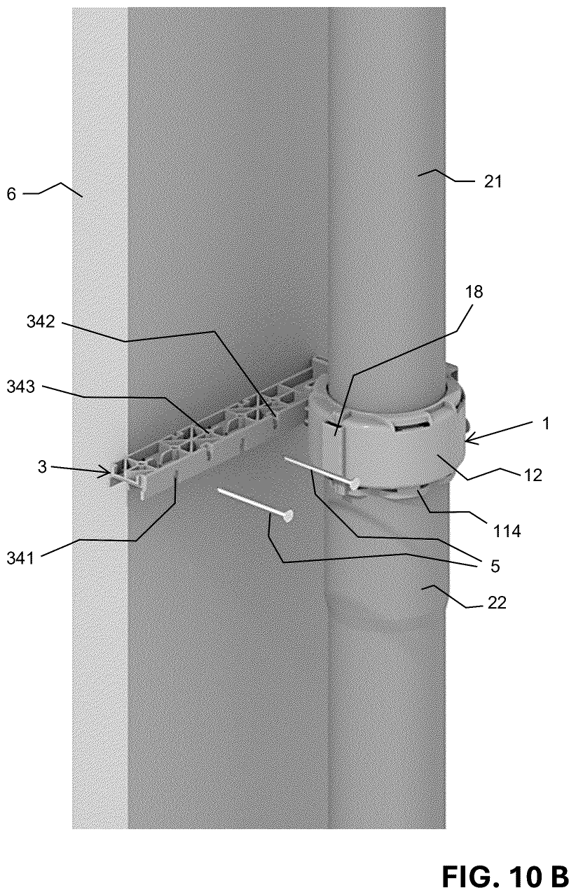

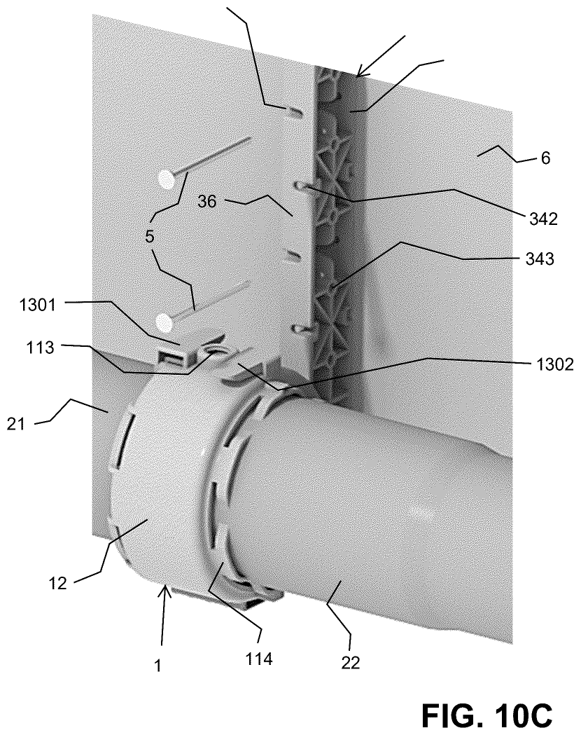

The hanger 3 may be provided on two right angled sided 35, 36 with holes 341, 342, 343 for easy installation of the hanger 3 to a support structure such as wall 6 by means of suitable means such as screws or nails 5, as shown in FIGS. 9 and 10. The first slots 311 and tabs 312 and second rails 321 and tabs 322 of the hanger shown in the present figures extend in direction of front side 35. The second slots 322 are positioned parallel to each other in the plane of the sidewall 36. The first slots 311 are positioned parallel to each other in the plane perpendicular to the longitudinal extension of supporting hanger 3.

On the opposite end 38 of connector connection part 33 the supporting hanger may be provided with a hanger elongation element 37, which basically has the same configuration as the hanger connection platform 115 in order to connect a second hanger (not shown) in the same way as the connection with the ring connector takes place.

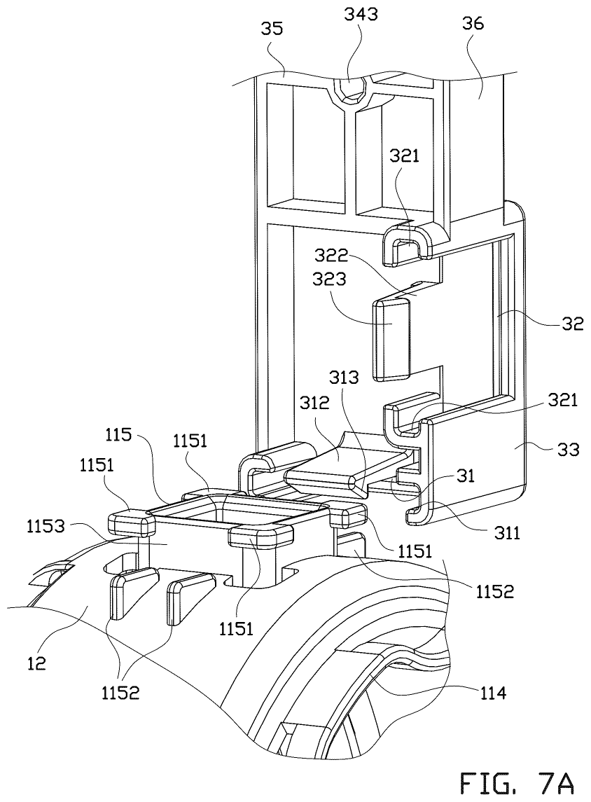

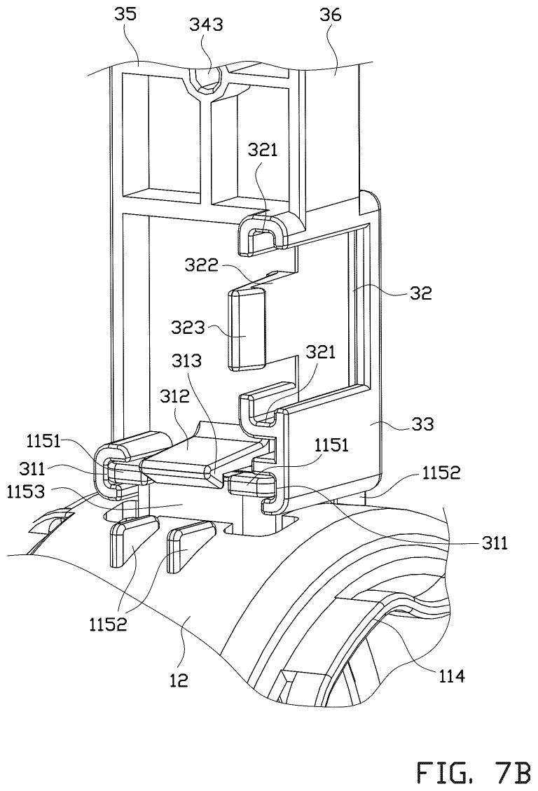

FIG. 7A and B show how the hanger 3 can be connected with the connector 1 via the hanger connection platform 115 in a direction in circumferential direction of the connector 3 and using the assembly of first slots 311 and corresponding tabs, hooks and restraining means by simply sliding the slots 311 over the elements 1151 laterally and outwardly projecting in the same plane from the top of the elevation 1153 of the hanger connection platform 115 as can best be seen in FIG. 7A. The hook 313 at the end of tab 312 extends downward to engage behind the top of said elevation 1153. The back of the hanger 3 forms a restraining means 31 on the opposite side of said hook so as to lock the top part of the hanger connection platform 115 between said hook 313 and said restraining means 31. This connects the hanger 3 securely and removably with the ring 1 as can best be seen in FIG. 7B. Additional support for this connection is formed by the provision of support fins 1152 which provide the lower end of hanger 3 with a firm basis in all directions and which prevent wobbling movements at the connection between hanger 3 and ring 1.

Because elements 1151 project outward of the top of elevation on both sides in longitudinal direction of the ring and on both sides in the direction perpendicular the slots 311 can be slid over the elements 1151 in four different orientations, namely in two opposite directions in circumferential direction of the ring 1 and in two opposite directions in the longitudinal direction of the connector 1, demonstrating the versatility of the combination of ring 1 and hanger 3.

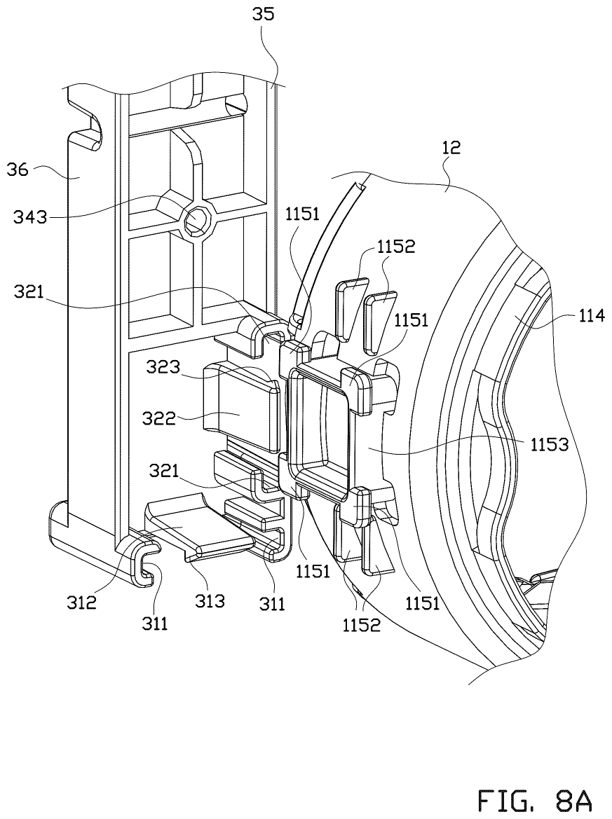

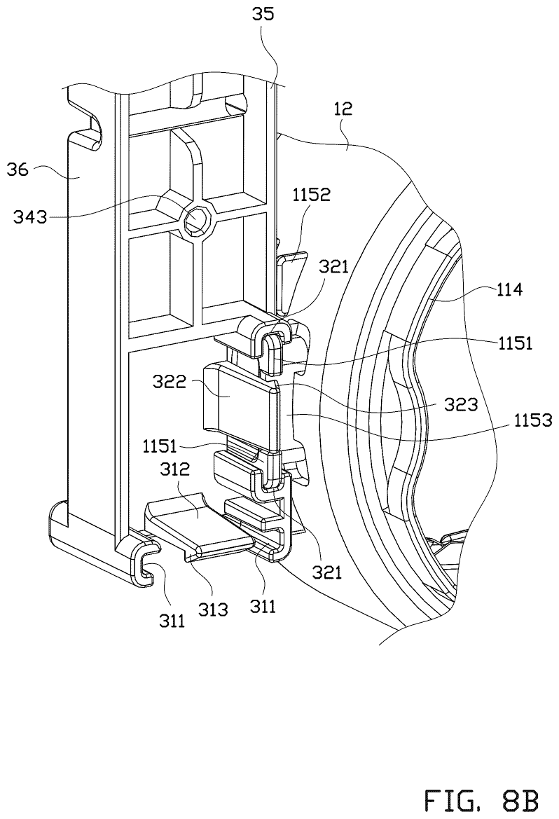

This versatility is even more enhanced by the provision of the second slots 321 and corresponding tabs, hooks and restraining means. These slots 321 extend in a direction perpendicular with respect to the longitudinal direction of the hanger 3 and are positioned opposite to each other in a plane in longitudinal direction of the hanger. In principle, apart from its orientation the assembly of second slots 321 and corresponding tabs, hooks and restraining means and its function correspond to that of the assembly of the first slots 311 and corresponding tabs, hooks and restraining means as is exemplified in FIG. 8.

FIG. 8A and B show how the hanger 3 can be connected with the connector 1 via the hanger connection platform 115 in a direction in longitudinal direction of the connector 3 and using the assembly of first slots 321 and corresponding tabs, hooks and restraining means by simply sliding the slots 321 over the elements 1151 laterally and outwardly projecting in the same plane from the top of the elevation 1153 of the hanger connection platform 115 as can best be seen in FIG. 8A. The hook 323 at the end of tab 322 extends downward to engage behind the top of said elevation 1153. The back of the hanger 3 forms a restraining means 32 on the opposite side of said hook so as to lock the top part of the hanger connection platform 115 between said hook 323 and said restraining means 32. This connects the hanger 3 securely and removably with the ring 1 as can best be seen in FIG. 8B. Also here, additional support for this connection is formed by the provision of support fins 1152 which provide the side 36 of the hanger 3 with a firm basis which prevent wobbling movements at the connection between hanger 3 and ring 1. Also slots 321 can be slid over the elements 1151 in four different orientations, namely in two opposite directions in circumferential direction of the ring 1 and in two opposite directions in the longitudinal direction of the connector 1, further demonstrating the versatility of the combination of ring 1 and hanger 3.

FIG. 9 shows how a connection by means of slots 311 of hanger 3, basically as described in reference to FIG. 7 can be used in various orientations. FIG. 9A shows an embodiment where the slots have been slid over projecting elements 1151 in circumferential direction of the ring 1. FIG. 9B shows an embodiment where the slots have been slid over projecting elements 1151 in longitudinal direction of the ring 1.

FIG. 10 shows how a connection by means of slots 321 of hanger 3, basically as described in reference to FIG. 8 can be used in various orientations. FIG. 10A shows an embodiment where the slots 321 have been slid over projecting elements 1151 in circumferential direction of the ring 1. FIG. 10B and C show embodiments where the slots 321 have been slid over projecting elements 1151 in longitudinal direction of the ring 1, with different orientations of pipes 21, 22.

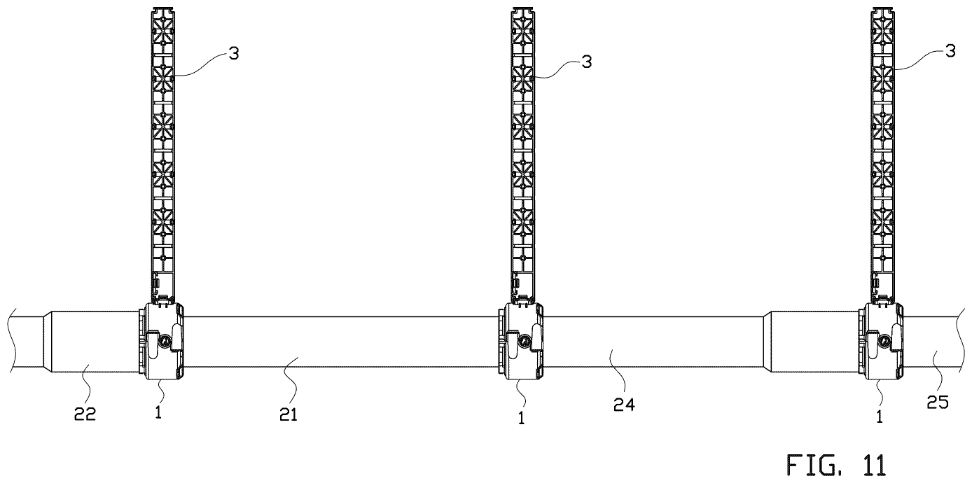

FIG. 11 shows an assembly of multiple pipes 22, 21, 24, 25 interconnected with rings 1, which are supported by supporting hangers 3, using slots 311.

FIG. 9-11 exemplify the versatility of the combination of ring 1 and supporting hanger 3 to support pipes 21, 22 to a support structure such as wall 6 in various piping orientations, using only a single type of supporting hanger 3 and only one type of connection element.

1. A combination of a ring and a supporting hanger, comprising
a ring for supporting one or more pipes and optionally connecting two pipes, wherein said ring comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto; and
a supporting hanger with an elongated shape, comprising two parallel first slots extending in a direction perpendicular with respect to the longitudinal direction of the hanger and which first slots are positioned opposite to each other in a plane perpendicular with respect to the longitudinal direction of the hanger and adapted to accommodate opposite laterally outwardly projecting elements extending from the top part of the elevation of the hanger connection platform of the ring and a tab between and in a staggered position with respect to the plane of said first slots, wherein said tab comprises a hook extending downward and configured to engage behind the top of said elevation and on the opposite side of said hook a restraining device so as to lock said top part of the hanger connection platform between said hook and said restraining device; and
comprising two parallel second slots extending in a direction perpendicular with respect to the longitudinal direction of the hanger and which second slots are positioned opposite to each other in a plane in longitudinal direction of the hanger and adapted to accommodate opposite laterally projecting elements extending from the top part of the elevation of the hanger connection platform of the ring and a tab between and in a staggered position with respect to the plane of said second slots, wherein said tab comprises a hook extending downward and configured to lock behind the top of said elevation and on the opposite side of said hook a restraining device so as to lock said top part of the hanger connection platform between said hook and said restraining device.

2. The combination according to claim 1, comprising said laterally and outwardly projecting elements in positions on each corner on top of the elevation, and wherein each element positioned on a said corner projects in longitudinal direction of the ring and in the direction perpendicular thereto.

3. The combination according to claim 2, wherein said laterally and outwardly projecting elements are positioned on each corner on top of the elevation with a recess between each neighboring element, which recess is configured to engage with a hook of a said tab of said supporting hanger.

4. The combination according to claim 1, wherein at least the top part of the elevation has a substantially square circumference.

5. The combination according to claim 1, wherein said elevation is a hollow, walled elevation having a substantially rectangular, preferably substantially square circumference.

6. The combination according to claim 1, wherein the ring comprises support fins on its outer side and positioned laterally adjacent from the hanger connection platform and dimensioned to abut the hanger when connected.

7. The combination according to claim 1, wherein the ring is configured with one or more adjustments for providing a tight grip on various diameters of pipes.

8. The combination according to claim 1, wherein the ring comprises a hinge extending in longitudinal direction of the ring and a cleft opposite to the hinge, so that upon opening of the ring the hinge separates two hinged halves of the ring; wherein
cavities are provided opposite to each other and aligned with each other on either side of the cleft, which cavities are provided with a thread so that upon closing the ring a threaded hole is provided.

9. The combination according to claim 1, wherein the hanger comprises at a first end a connector connection part configured for connection with said hanger connection platform, and wherein said connector connection part comprises said first and second slots and corresponding tabs, hooks and restraining device.

10. The combination according to claim 1, wherein the hanger comprises at a second end opposite to said first end hanger elongation element, configured to connect a second hanger thereto.

11. The combination according to claim 1, wherein said hanger is in the shape of an elongated slat.

12. The combination according to claim 9, wherein the hanger is provided on two right angled sides with holes for installation of the hanger to a supporting structure.

13. A ring for supporting one or more pipes and optionally connecting two pipes, wherein said ring comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto.

14. The ring according to claim 13, comprising said laterally and outwardly projecting elements in positions on each corner on top of the elevation, and wherein each element positioned on a said corner projects in longitudinal direction of the ring and in the direction perpendicular thereto.

15. The ring according to claim 14, wherein said laterally and outwardly projecting elements are positioned on each corner on top of the elevation with a recess between each neighboring element.

16. The ring according to claim 13, wherein at least the top part of the elevation has a substantially square circumference.

17. The ring according to claim 13, wherein said elevation is a hollow, walled elevation having a substantially rectangular, preferably substantially square circumference.

18. The ring according to claim 13, wherein the ring comprises support fins on its outer side and positioned laterally adjacent from the hanger connection platform and dimensioned to abut the hanger when connected.

19. The ring according to claim 13, wherein the ring is configured with one or more adjustments for providing a tight grip on various diameters of pipes.

20. The ring according to claim 13, wherein the ring comprises a hinge extending in longitudinal direction of the ring and a cleft opposite to the hinge, so that in an opened position of the ring the hinge separates two hinged halves of the ring; wherein
cavities are provided opposite to each other and aligned with each other on either side of the cleft, which cavities are provided with a thread such that upon closing the ring a threaded hole is provided.

21. A supporting hanger with an elongated shape for connecting with the ring as claimed in claim 13, comprising two first slots opposite to each other in a plane perpendicular with respect to the longitudinal direction of the hanger and adapted to accommodate opposite projections extending from the top part of the elevation of the hanger connection platform of the ring and a tab between and in a staggered position with respect to the plane of said first slots, wherein said tab comprises a hook extending downward and configured to lock behind the top of said elevation and on the opposite side of said hook a restraining device so as to lock said top part of the hanger connection platform between said hook and said restraining device; and
comprising two second slots opposite to each other in a plane in longitudinal direction of the hanger and adapted to accommodate opposite projections extending from the top part of the elevation of the hanger connection platform of the ring and a tab between and in a staggered position with respect to the plane of said second slots, wherein said tab comprises a hook extending downward and configured to lock behind the top of said elevation and on the opposite side of said hook a restraining device so as to lock said top part of the hanger connection platform between said hook and said restraining device.

22. The supporting hanger according to claim 21, wherein the hanger comprises at a first end a connector connection part configured for connection with said hanger connection platform of a ring which comprises a hanger connection platform comprising an elevation extending from the outer side of the ring, wherein at least the top part of the elevation has a substantial rectangular circumference and one or more elements laterally and outwardly projecting in the same plane from the top of the elevation on both sides in longitudinal direction of the ring and on both sides in the direction perpendicular thereto, and wherein said connector connection part comprises said first and second slots and corresponding tabs, hooks and restraining device.

23. The supporting hanger according to claim 22, wherein the hanger comprises at a second end opposite to said first end a hanger elongation element, configured to connect a second hanger thereto.

24. The supporting hanger according to claim 21, wherein said hanger is in the shape of an elongated slat.

25. The supporting hanger according to claim 24, wherein the hanger is provided on two right angled sides with holes for installation of the hanger to a supporting structure.

26. Computer-readable medium having computer-executable instructions adapted to cause a 3D printer to print the ring according to claim 13.

27. Computer-readable medium having computer executable instructions adapted to cause a 3D printer to print the hanger as claimed in claim 21.
